(19) United States
(12) Patent Application Publication
(10) Pub. No.: US 2006/0039240 A1
(43) Pub. Date: Feb. 23, 2006

(54) 100 Based Stopwatch, with abilty to cumulate time in seconds, minutes and tenths and one hundreds of minutes, and hours and tenths and one hundreds of hours.

(76) Inventor: Jonathan French Sutter, Seattle, WA (US)

Correspondence Address: JONATHAN SUTTER, 9646 47TH AVENUE SW, SEATTLE, WA, 98136, US

(21) Appl. No.: 10/711,057

(22) Filed: Aug. 19, 2004

(51) Int. Cl. G04C 17/00; G04F 8/00

(52) U.S. Cl. 368/110

(57) ABSTRACT

A stopwatch with a 100 base of hours, minutes and seconds will provide direct calculation of the time differential between observed operations. The watch will display 999,999 seconds, or 9999.99 minutes, or 9999.99 hours. The watch will use a display of 6 digits. For accumulating seconds, all digits will be used without a decimal point. Total seconds available will be 999,999. If this total is exceeded, the time will automatically convert to accumulated minutes and tenths and hundreds of minutes. For accumulating minutes and tenths and hundreds of minutes, minutes will be accumulated to 9999.99. If this total is exceeded, the time will automatically convert to hours and tenths and hundreds of hours. A display mode indicator will be used to shift between seconds, minutes, or hours. Changing the mode will convert the time accumulated to the seconds, minutes, or hours selected.

### DETAILED DESCRIPTION

For the purpose of computing the time differential between multiple sequential events, I hereby record the invention of a time accumulating stop watch based on 100, tenths and hundreds.

The watch is to cumulate seconds, or minutes and tenths and hundreds of minutes, or hours and tenths and hundreds of hours as selected by the operator. The time can be paused and then restarted by the same action of current available stop watches. The accumulated time can be cleared to zero by the same action of current available stop watches.

1. The mode function of current available stop watches will be expanded by software modification to cumulated in seconds, or minutes, or hours mode. If the time is stopped, switching the mode function will convert the seconds time to minutes and tenths and hundreds of minutes, or hours and tenths and hundreds, as the mode selector is cycled through all the modes. The current available modes on the stop watch will remain available and operative.
